(19) United States
(12) Patent Application Publication
(10) Pub. No.: US 2012/0089478 A1
(43) Pub. Date: Apr. 12, 2012

(54) METHODS, SYSTEMS, AND COMPUTER READABLE MEDIA FOR USING STORED CONJOINT ANALYSIS SOFTWARE ITERATION DATA IN CONJOINT ANALYSIS OF DIFFERENT PRODUCT OR SERVICE COMBINATIONS

(76) Inventors: Colleen Murphy, Chicago, IL (US); Rich Shopmyer, Hillsborogh, NC (US); William Haywood Craige Ruffin, Chapel Hill, NC (US)

(21) Appl. No.: 13/251,775

(22) Filed: Oct. 3, 2011

Related U.S. Application Data
(60) Provisional application No. 61/388,908, filed on Oct. 1, 2010.

(51) Int. Cl. G06Q 30/00

(52) U.S. Cl. 705/26.7

(57) ABSTRACT

The subject matter described herein includes methods, systems, and computer readable media for using stored conjoint analysis software iteration data in conjoint analysis of different product or service combinations. A method for using stored conjoint analysis software iteration data in conjoint analysis of different product or service combinations is provided. The method includes, storing, in memory accessible by a computer, conjoint analysis software iteration data from an iteration of the conjoint analysis software against a first set of product or service combinations and using the stored conjoint analysis software iteration data as input to conjoint analysis software being executed.

### PRIORITY CLAIM

This application claims the benefit of U.S. Provisional Patent Application Ser. No. 61/388,908 filed Oct. 1, 2010; the disclosure of which is incorporated herein by reference in its entirety.

### TECHNICAL FIELD

The subject matter described herein relates to performing conjoint analysis using stored user input information or stored importance profile data from previous iterations of conjoint analysis software. More particularly, the subject matter described herein relates to methods, systems, and computer readable media for using stored conjoint analysis software iteration data in conjoint analysis of different product or service combinations.

### BACKGROUND

Conjoint analysis software assists users in simplifying difficult product or service choice decisions. Based on user responses (or inputs) to the conjoint analysis software, the conjoint analysis software creates a profile of what is important to the user for a product or service. This profile is referred to as the personalized importance profile or importance profile, defined as a mathematical representation of the relative importance that the user places on features or attributes when choosing a product or service. This importance profile can be used to calculate the part-worth utility the user derives from a feature level of a specific attribute for a product or service. The importance profile is also used to calculate the total utility (or worth) the user would derive from a product or service with a defined set of feature levels.

The user importance profile is used to calculate the total utility for each product or service in the user choice set, (the product or service currently available to the user) with the results presented to the user from best fit (highest total utility) to worst fit (lowest total utility).

Requiring a user to input answers to the questions presented by conjoint analysis software each time the user iterates the conjoint analysis software is cumbersome to the user. Accordingly, there exists a need for methods, systems, and computer readable media for using stored conjoint analysis software iteration in conjoint analysis of different product or service combinations.

### SUMMARY

The subject matter described herein includes methods, systems, and computer readable media for using stored conjoint analysis software iteration data in conjoint analysis of different product or service combinations. According to one aspect of the subject matter described herein, a method for using stored conjoint analysis software iteration data against different product or service combinations is provided. The method includes, storing, in memory accessible by a computer, conjoint analysis software iteration data from an iteration of the conjoint analysis software against a first set of product or service combinations. The method further includes, executing, using a processor, the same or different conjoint analysis software against a second set of product or service combinations different from the first set of product or service combinations and using the stored conjoint analysis software iteration data as input to the conjoint analysis software being executed. The method further includes, outputting, to the user via an output device, relative fits of the product or service combinations in the second set based on the stored conjoint analysis software iteration data.

The subject matter described herein for using stored conjoint analysis software iteration data in conjoint analysis of different product or service combinations may be implemented in software in combination with hardware and/or firmware. As such, the terms function or module as used herein refer to software in combination with hardware and/or firmware for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary system for using stored conjoint analysis software iteration data in conjoint analysis of different product or service combinations according to an embodiment of the subject matter described herein; and

FIG. 2 is a flow chart illustrating an exemplary process for using stored conjoint analysis software iteration data in conjoint analysis of different product or service combinations according to an embodiment of the subject matter described herein.

### DETAILED DESCRIPTION

### Exemplary Implementation

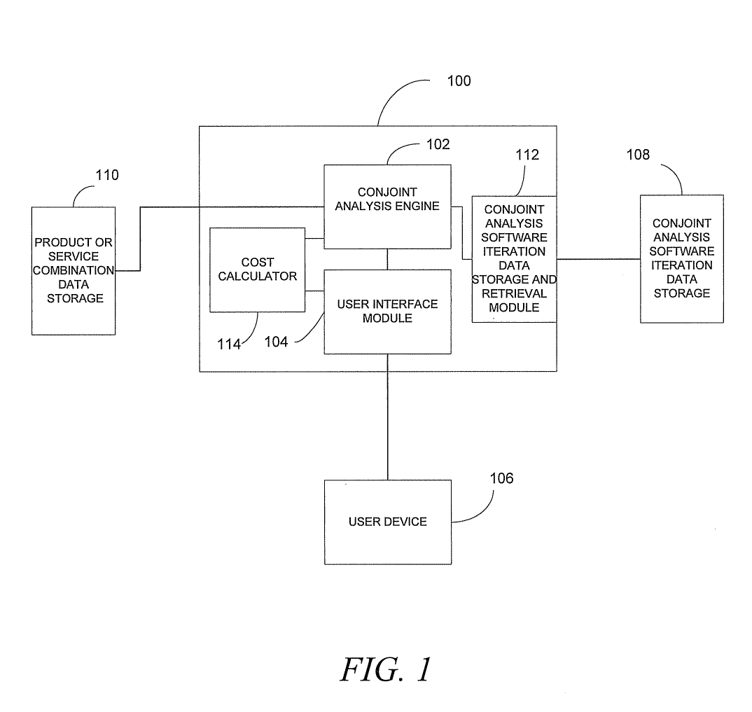

FIG. 1 is a block diagram of an exemplary system for using stored conjoint analysis software iteration data in conjoint analysis of different product or service combinations according to an embodiment of the subject matter described herein. The term “conjoint analysis software iteration data,” as used herein, refers to any data provided as input, produced as output, or used or produced as an intermediate value by conjoint analysis software during an iteration or execution of the conjoint analysis software. Referring to FIG. 1, a server 100 or other suitable computing platform implements a conjoint analysis engine 102 and a user interface module 104. Conjoint analysis engine 102 performs conjoint analysis based on input received from a user via user device 106 and user interface module 104. For example, user interface module 104 may present to the user sets of paired tradeoff questions via a graphical user interface regarding different attributes of product or service combinations that have many different attributes. One example of such a product or service combination is a health plan (e.g., an insurance plan for medical, dental, or vision services) or prescription drug plan. Different health plans have different features. It is difficult for a user to select and compare one health plan or prescription drug plan to another. To simplify the process, user interface module 104 presents a user with questions regarding different extremes of an attribute. For example, a user may be asked whether the user prefers a health plan with a high deductible and a low premium or a low premium and a high deductible. The user is typically asked a series of such questions and the results are input into conjoint analysis engine 102.

Conjoint analysis engine 102 performs a statistical analysis technique called conjoint analysis. In conjoint analysis, importance of single attribute data is gathered from the user input and the difference in importance of two attributes is gathered. Using regression analysis, both types of data are analyzed together as a single set of information. The result of the regression analysis is a single number for each attribute indicating a final estimate of how the user feels the attribute is important on a numeric scale. The attributes are used to compute a score that indicates the relative utility (or “fit”) of each product or service design. The scores are presented along with each product or service and output to the user via user device 106. An exemplary conjoint analysis engine and algorithm is described in U.S. Pat. No. 6,826,541, the disclosure of which is incorporated herein by reference in its entirety.

As stated above, one problem with conjoint analysis is that the user is required to input his or her preferences each time the conjoint analysis software is executed. Because product alternatives in a given choice set change over time (for example, health plans change from year to year) and a user may not desire to reenter any or all of his or her user information, the subject matter described herein includes user input storage 108 that stores user preference data from prior iterations of the conjoint analysis software so that the user input can be used against different combination products or services 110, that are available at different times, for example. In one example, storage 108 may include the user input to the paired trade off and importance of difference questions referenced above. In such an example, the user may choose to view the user's stored inputs from a previous iteration of conjoint analysis software and determine whether to change any of the previous inputs based on changed or new preferences of the user. Conjoint analysis engine 102 may then execute based on the previously entered user input that was unchanged and any changed or new user input.

In another example, the conjoint analysis software iteration data stored in conjoint analysis software iteration data storage 108 may include importance profiles calculated from user inputs during a previous iteration of the conjoint analysis software. An importance profile for a given user may be a set of values that indicates the relative importance of a group of attributes to a user. The values may be calculated by conjoint analysis engine 102. Table 1 shown below illustrates an example of an importance profile that may be stored for an iteration of conjoint analysis software for selecting a health plan.

TABLE 1
Stored Importance Profile

| Attribute | Utility Value |
|---|---|
| Bi-weekly contribution | 5 |
| Chiropractic care coverage | 8 |
| Annual deductible | 6 |
| Your cost per specialist visit | 4 |

In Table 1, the importance profile for an iteration of conjoint analysis software for selecting a health plan includes utility values for attributes, such as settings of deductibles and premiums. These attribute utility values, which represent the “worth” a user derives from a given feature level, are calculated by performing matrix transformation using importance rating responses and tradeoff responses (as the Y vector) and a design matrix (the X matrix) which represents which attributes were presented to the user. The resulting regression coefficients can represented as point slope formulas which can be used to “score” product performance and calculate part worth and total utility values. Either the stored calculated attribute utility values and/or the user inputs (i.e., importance ratings, tradeoff responses) from which the utility values are calculated, may be used during a subsequent iteration of the same or different conjoint analysis software involving the same attributes to expedite or facilitate the weightings of products or services during the subsequent iteration.

Continuing with the health plan example, a user may input health plan preference data during an enrollment period one year and store that information. The next year when new health plans or new features are available, the user is not required to re-enter all of the data from the previous iteration of the conjoint analysis software again. The user can select an option to use the stored conjoint analysis software iteration information and have the conjoint analysis software iteration information be used by conjoint analysis engine 102 against the new combinations of health plans. A conjoint analysis software iteration data storage and retrieval module 112 retrieves data from previous conjoint analysis iterations and provides the data to conjoint analysis engine 102. As set forth above, the data that is used may be the user input, importance profile data calculated from the user input, or a combination thereof. Conjoint analysis engine 102 uses the retrieved data to compute relative utilities of the new or different combination of products or services.

According to another aspect of the subject matter described herein, a cost calculator, which projects total expected costs based on a user defined profile of expected health care usage 114, may be used in conjunction with the conjoint results to assist users with selecting a plan option. Cost calculator engines are configured for each plan option in the choice set. Users are asked to provide a profile of expected future medical usage. The usage estimates serve as inputs to the calculator engine, the output being the expected estimated out-of-pocket cost of each plan. These projected costs can be rerun as product alternatives change in the choice set (i.e. plan designs change). In addition, the projected per plan costs can be used as an input to the conjoint analysis engine to calculate fit of product choices over time. Specifically, an attribute can be included in the conjoint analysis software to measure the utility of “expected out-of-pocket cost.” The estimates of medical usage serves as a health care utilization profile which can compute estimated out-of-pocket costs for plans which becomes a plan feature level used in conjunction with a preference profile to calculate product fit (total utility).

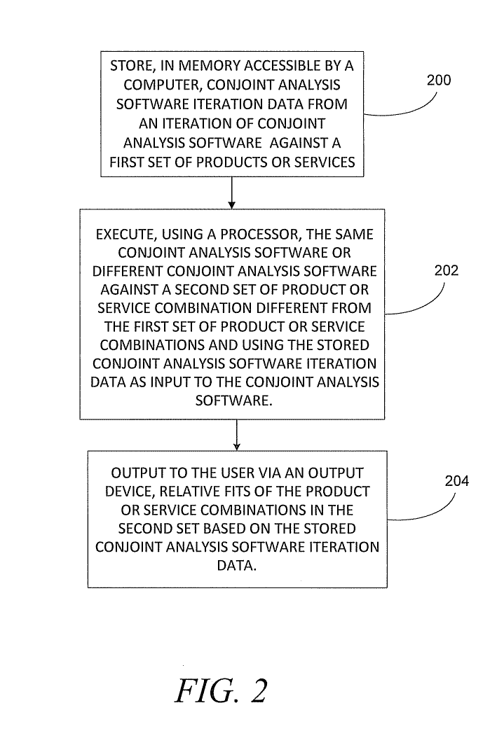

FIG. 2 is a flow chart illustrating exemplary steps for using stored conjoint analysis software iteration data in conjoint analysis of different product or service combinations. Referring to FIG. 2, in step 200, conjoint analysis software iteration data obtained from or during execution of the conjoint analysis software against a first set of product or service combinations is stored in memory accessible by a computer. For example, conjoint analysis software iteration data storage and retrieval module 112 may store data obtained during a first execution of conjoint analysis software in memory, such as conjoint analysis software iteration data storage 108 illustrated in FIG. 1. Conjoint analysis software iteration data storage 108 may be nonvolatile storage, such as a disk array that is accessible by a computer.

In step 202, the same or different conjoint analysis software is executed against a different set of product or service combinations from the first set and uses the stored conjoint analysis software iteration data as input. For example, conjoint analysis software data storage and retrieval module 112 may retrieve the stored data from storage 108, and conjoint analysis engine 102 or a different conjoint analysis engine may use the retrieved data in a conjoint analysis, rather than requiring the user to go through the action of answering the paired tradeoff questions to provide answers data for the second conjoint analysis. Alternatively, as set forth above, the user may change some or all of the user's answers and the changed answers may be used in combination with the stored answers or the stored calculated importance values for each attribute in the subsequent conjoint analysis. In step 204, relative fits of product or service combinations in the second set is output to the user based on the storage user input. For example, conjoint analysis engine 102 may calculate scores for each product or service combination where the relative values of the scores indicate the relative fit or total utility (to the user) of product or service combinations being offered to the user using the stored data and output that information to a user via user interface module 104. In a health plan example, the health plan that most closely matches a user's preferences may be given a score of 10 on a scale of 1 to 10, and other health plans with lower matches to the user's stated preferences may score less than 10.

The following examples are additional uses of the subject matter described herein.
1. The personalized importance profile created by the conjoint analysis engine can be stored and used to quantify performance of changing choice sets over time. As choice sets change, best fit results can be recalculated and presented to users.

In its current implementation, the importance profile is used to calculate the fit of each product or service in the user's current choice set (a snapshot in time). These saved profiles can be used in conjunction with system that maintains changes to products/services for which the user is eligible to automatically calculate fit to new products or services (or altered products or services).

Using a set of stored user importance profiles as products evolve (e.g., prices change, features change), at given intervals (or continually) the user choice set can be updated with current products or services and best fit results can be recalculated. These results can be provided to the user.
2. Generalized importance profiles can be developed from one or more user personalized importance profiles and used to predict product or service performance in other categories.

The engine generates an importance profile that represents the relative importance of features to a user for a product category. These importance profiles in part or in whole, by themselves or in combination with other product or service importance profiles for the user, can be used to predict the best fit results for other product or service categories (for which the user does not have an importance profile).

Features (attributes) specific to a product category can be generalized to broader preferences that can be used to create user-level general preferences about products or services. Such general importance profiles can hold predictive power when identifying the best fits for a user for other products and services not explicitly rated by the user. For example, the relative importance of a set of cost-related attributes can be used as inputs to calculate a general price sensitivity measure of the user (other general categories might include convenience, safety, risk aversion). By creating these general preference profiles (based on one or more actual personalized importance profiles for a user), predictions can be made for new categories of products services (not measured directly with the user) to identify relative performance of items in the choice set. These predicted best fit results could be used to help the user identify products and services that best fit their needs.
3. Sets of personalized importance profiles can be used to segment users and predict product performance in other categories.

Using common statistical techniques that identify groupings of users based on similar response patterns (e.g., cluster analysis), sets of user importance profiles can be used to create subpopulations/segments of users with similar importance profile structures. Cluster membership in one product or service category may then be used to predict best fit results for a user for another product category for a user (that has no profile for that category), based on the importance profiles of other segment members of have profiles for the other product category.

For example, if for product category X, user A is assigned to segment 1 based on his/her importance profile for product category X, if other members of segment 1 have importance profiles created for product category Y, predictions can be made about best fit results of products in product category Y for user A (based on results for others in segment 1).

In one specific example, a user may complete execution of conjoint analysis software to select a health plan for the user. The importance profile created as a result of the execution of the conjoint analysis software may identify the user as one who places relatively high importance on financial security of the user's family. The identification of the user as placing high relative importance on financial security may be used to help the same user select an automobile that best fits the financial security preference for that user, without requiring the user to execute the conjoint analysis software a second time to select an automobile. In this example, higher relative utility may be determined for cars with higher safety ratings, because safety is important to financial security.
4. Medical usage profiles can be stored and used to calculate performance of changing choice sets. As choice sets change, total out-of-pocket results can be recalculated and presented to users.

Cost calculator 114 illustrated in FIG. 1 predicts total out-of-pocket cost for medical plans based on user provided estimates of use for common medical services. For example, users provide their estimates of primary care visits, specialist visits and prescription drugs for the coming year. The present subject matter may include a set of plan cost structure engines that use these medical usage profiles to calculate the total out-of-pocket cost for each plan in the user's choice set.

Saved medical usage profiles can be used in conjunction with a system that maintains changes to the cost structure of plans to automatically calculate out-of-pocket costs for new plans (or altered plans). As the choice set changes, out-of-pocket costs can be recalculated for products within the user's choice set. These results can be provided to the user.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for using stored conjoint analysis software iteration data in conjoint analysis of different product or service combinations, the method comprising:
storing, in memory accessible by a computer, conjoint analysis software iteration data from an iteration of conjoint analysis software for determining relative fits of product or service combinations in a first set of product or service combinations;
executing, using a processor, the same conjoint analysis software or different conjoint analysis software against a second set of product or service combinations different from the first set and using the stored conjoint analysis software iteration data as input to the conjoint analysis software being executed; and
outputting, to the user via an output device, results of the execution of the conjoint analysis software indicating relative fits of the product or service combinations in the second set based on the stored conjoint analysis software iteration data.

2. The method of claim 1 where the conjoint analysis software iteration data includes user input to questions presented by the conjoint analysis software during the iteration of the conjoint analysis software against the first set of product or service combinations.

3. The method of claim 1 wherein the conjoint analysis software iteration data includes an importance profile generated by the conjoint analysis software during the iteration of the conjoint analysis software against the first set of product or service combinations.

4. The method of claim 1 wherein the first and second sets of product or service combinations include health plans available to users at different times.

5. The method of claim 1 wherein the first and second sets of product or service combinations include prescription drug plans available to users at different times.

6. The method of claim 1 comprising presenting the user with an option to store the conjoint analysis software iteration data during an iteration of the conjoint analysis software as a subscription service.

7. The method of claim 1 comprising requesting medical usage information from the user and wherein outputting the relative fits includes considering the medical usage information in addition to the user preference information to determine the relative fits of the product or service combinations in the second set.

8. The method of claim 7 comprising predicting and outputting to the user estimated medical costs for each of the product or service combinations in the second set based on the medical usage information.

9. The method of claim 1 comprising identifying the user as being a member of a subpopulation of users based on the conjoint analysis software iteration data from the iteration of the conjoint analysis software against the first set of product or service combinations and wherein executing the conjoint analysis software against the second set of product or service combinations includes using the subpopulation to which the user belongs to predict best fit results of the product or service combinations in the second set.

10. The method of claim 1 comprising generating an average profile based on conjoint analysis software iteration data for a plurality of users that execute the conjoint analysis software against the first set of product or service combinations and using the average profile to indicate relative utility of product or service combinations in the first set for a user who has not executed the conjoint analysis software but whose demographics or preferences match the average profile.

11. A system for using conjoint analysis software iteration data in conjoint analysis of different product or service combinations, the system comprising:
a conjoint analysis software iteration data storage and retrieval module for storing, in memory accessible by computer, conjoint analysis software iteration data from an iteration of conjoint analysis software against a first set of product or service combinations;
a conjoint analysis engine for performing conjoint analysis against a second set of product or service combinations different from the first set using the stored conjoint analysis software iteration data as input to the conjoint analysis software being executed; and
a user interface module for outputting, to the user via an output device, results of the execution of the conjoint analysis software indicating relative fits of the product or service combinations in the second set based on the stored conjoint analysis software iteration data.

12. The system of claim 11 where the conjoint analysis software iteration data includes user input to questions presented by the conjoint analysis software during the iteration of the conjoint analysis software against the first set of product or service combinations.

13. The system of claim 11 wherein the conjoint analysis software iteration data includes an importance profile generated by the conjoint analysis software during the iteration of the conjoint analysis software against the first set of product or service combinations.

14. The system of claim 11 wherein the first and second sets of product or service combinations include health plans available to users at different times.

15. The system of claim 11 wherein the first and second sets of product or service combinations include prescription drug plans available to users at different times.

16. The system of claim 11 wherein the user input module is configured to present the user with an option to store the user input during an iteration of the conjoint analysis software as a subscription service.

17. The system of claim 11 wherein the user input module is configured to obtain medical usage information from the user and wherein the conjoint analysis engine is configured to use the medical usage data in calculating the relative fits.

18. The system of claim 17 wherein estimated total product costs, calculated from the obtained medical usage information are used as inputs to the conjoint analysis engine to estimate the relative fits.

19. The system of claim 18 comprising a cost calculator for using the obtained medical usage information to project total estimated costs of product or service combinations in the second set.

20. The system of claim 11 wherein the conjoint analysis engine is configured to identify the user as being a member of a subpopulation of users based on the conjoint analysis software iteration data the iteration of the conjoint analysis software against the first set of product or service combinations and wherein executing the conjoint analysis software against the second set of products or service combinations includes using the subpopulation to which the user belongs to predict best fit results of the product or service combinations in the second set.

21. The system of claim 11 wherein the conjoint analysis engine is configured to generate an average profile based on conjoint analysis software iteration data for a plurality of users that execute the conjoint analysis software against the first set of product or service combinations and using the average profile to indicate relative utility of product or service combinations in the first set for a user who has not executed the conjoint analysis software but whose demographics or preferences match the average profile.

22. A non-transitory computer readable medium having stored thereon executable instructions that when executed by the processor of a computer control the computer to perform steps comprising:
storing, in memory accessible by a computer, conjoint analysis software iteration data from an iteration of conjoint analysis software for determining relative fits of product or service combinations in a first set of product or service combinations;
executing, using a processor, the same conjoint analysis software or different conjoint analysis software against a second set of product or service combinations different from the first set and using the stored conjoint analysis software iteration data as input to the conjoint analysis software being executed; and
outputting, to the user via an output device, results of the execution of the conjoint analysis software indicating relative fits of the product or service combinations in the second set based on the stored conjoint analysis software iteration data.
